(19) United States
(12) Patent Application Publication
(10) Pub. No.: US 2025/0068324 A1
(43) Pub. Date: Feb. 27, 2025

(54) MULTI-TOUCH DATA INPUT METHOD AND DEVICE, POINT OF SALE, AND COMPUTER-READABLE STORAGE MEDIUM

(71) Applicant: SHENZHEN PAX SMART NEW TECHNOLOGY CO., LTD., Shenzhen (CN)

(72) Inventors: Chenghe YANG, Shenzhen (CN); Linfeng ZHENG, Shenzhen (CN); Zhipeng XIE, Shenzhen (CN)

(21) Appl. No.: 18/724,927

(22) PCT Filed: Oct. 18, 2022
(86) PCT No.: PCT/CN2022/125962

§ 371 Date: Jun. 27, 2024

(30) Foreign Application Priority Data
Dec. 28, 2021 (CN) 202111630873.7

(51) Int. Cl. G06F 3/04883; G07G 1/00

(52) U.S. Cl. CPC G06F 3/04883; G07G 1/00; G06F 2203/04104

(57) ABSTRACT

The present application relates to the technical field of point of sales, and provides a multi-touch data input method and device, a point of sale, and a computer-readable storage medium. The method includes: entering a security input mode when a preset touch event is detected; determining target information according to a preset double click event when the preset double click event is detected within a preset time period; determining a corresponding target data based on the target information and storing the target data; and uploading the target data to an application layer and exiting the security input mode when an input is detected to have been completed.

### CROSS REFERENCE TO RELATED APPLICATIONS

The present application is a National Stage Application of International Patent Application No. PCT/CN2022/125962, filed date of Oct. 18, 2022, and claims priority of Chinese patent application, with application No. 202111630873.7, filed on Dec. 28, 2021; the contents each of which are incorporated herein by reference.

### TECHNICAL FIELD

The present application relates to the technical field of point of sales, and more specifically to a multi-touch data input method and device, a point of sale, and a computer-readable storage medium.

### BACKGROUND

At present, the application field of point of sale POS with an intelligent touch screens is becoming more and more extensive. When the point of sale POS is used or sales payment operations, the action of entering a password is required.

The point of sale devices available to visually impaired users usually support password input operations through the addition of Braille physical components. However, the above methods have high costs and poor applicability, so that this type of point of sale is difficult to promote, and the usage rate of visually impaired users is reduced.

### SUMMARY

Embodiments of the present application provide a multi-touch data input method and device, a point of sale, and a computer-readable storage medium, which can solve the problem that data input methods used for related visual impairments usually require high costs and have poor applicability.

In a first aspect, an embodiment of the present application provides a multi-touch data input method, which is applied to a security processor, and the multi-touch data input method includes:
entering a security input mode when a preset touch event is detected;
determining target information according to a preset double click event when the preset double click event is detected within a preset time period;
determining a corresponding target data based on the target information and storing the target data; and
uploading the target data to an application layer and exiting the security input mode when an input is detected to have been completed.

In a second aspect, an embodiment of the present application provides a multi-touch data input device, which is applied to a security processor, and the multi-touch data input device includes:
a first detection module, configured for entering a security input mode when a preset touch event is detected;
an information obtaining module, configured for determining target information according to a preset double click event when the preset double click event is detected within a preset time period;
a determination module, configured for determining a corresponding target data based on the target information and storing the target data; and
an upload module, configured for uploading the target data to an application layer and exiting the security input mode when an input is detected to have been completed.

In a third aspect, an embodiment of the present application provides a point of sale, which includes a security processor and a computer program stored and operable on the security processor, and the security processor implements the method according to the first aspect when executing the computer program.

In a fourth aspect, an embodiment of the present application provides a computer-readable storage medium stores a computer program, and the method according to the first aspect is implemented when the computer program is executed by the security processor

In a fifth aspect, an embodiment of the present application provides a computer program product that, when running on a point of sale, causes the point of sale to execute the method according to the first aspect.

### Beneficial Effects

The beneficial effect of the embodiment of the present application when comparing to the existing technology is that the multi-touch signals of the touch screen is supported and processed through the security processor, which achieves data input operations based on software logic instead of relying on Braille physical components; the device cost of the point of sale is reduced, the applicability of the point of sale is improved, and the security and efficiency of password input operations for visually impaired users are improved.

It can be understood that the beneficial effects of the second to fifth aspects mentioned above can be found in the relevant description of the first aspect, which will not be further elaborated herein.

### BRIEF DESCRIPTION OF THE DRAWINGS

In order to explain the embodiments of the present application more clearly, a brief introduction regarding the accompanying drawings that need to be used for describing the embodiments of the present application or the prior art is given below; it is obvious that the accompanying drawings described as follows are only some embodiments of the present application, for those skilled in the art, other drawings can also be obtained according to the current drawings on the premise of paying no creative labor.

FIG. 1 is a schematic flowchart of a multi-touch data input method provided in an embodiment of the present application;

FIG. 2 is a schematic flowchart of a step S102 of a multi-touch data input method provided in an embodiment of the present application:

FIG. 3 is a schematic flowchart of a step S103 of a multi-touch data input method provided in an embodiment of the present application:

FIG. 4 is a schematic diagram of a data input region provided in an embodiment of the present application:

FIG. 5 is a structural schematic diagram of a multi-touch data input device provided in an embodiment of the present application; and

FIG. 6 is a structural schematic diagram of a point of sale provided in an embodiment of the present application.

### DETAILED DESCRIPTION OF EMBODIMENTS

In the following description, specific details such as specific system structure, technology, etc. are proposed for the purpose of illustration rather than limitation, in order to thoroughly understand the embodiments of the present application. However, those skilled in the art should be aware that the present application can also be implemented in other embodiments without these specific details. In other cases, detailed descriptions of well-known systems, devices, circuits, and methods may be omitted to avoid unnecessary details hindering the description of the present application.

It should be understood that when used in the present application and the accompanying claims, the term “including” indicates the presence of the described features, whole, step, operation, elements, and/or components, but does not exclude the presence or addition of one or more other features, whole, step, operation, elements, components, and/or sets thereof.

It should also be understood that the terms “and/or” used in the present application and the accompanying claims refer to any combination and all possible combinations of one or more of the related listed items, and include these combinations.

As used in the present application and the accompanying claims, the term “if” may be interpreted in context as “when” or “once” or “in response to determination” or “in response to detection”. Similarly, the phrases “if [described condition or event] is determined” or “if [described condition or event] is detected” can be interpreted according to context as meaning “once determined” or “in response to determination” or “once [described condition or event] is detected” or “in response to detected [described condition or event]”.

Furthermore, in the description of the present application and the accompanying claims, the terms “first”, “second”, “third”, etc. are only used to distinguish the description and cannot be understood as indicating or implying relative importance.

The reference to “one embodiment” or “some embodiments” described in the present application specification means that specific features, structures, or features described in conjunction with the embodiments are included in one or more embodiments of the present application. Therefore, the statements “in one embodiment”, “in some embodiments”, “in other embodiments”, “in further other embodiments”, etc. that appear differently in this specification do not necessarily refer to the same embodiment, but rather mean “one or more but not all embodiments”, unless otherwise emphasized. The terms “including”, “comprising”, “having”, and their variations all mean “including but not limited to”, unless otherwise emphasized.

The multi-touch data input method provided in the embodiments of the present application can be applied to terminal devices such as point of sales including a security processor (SP). The embodiments of the present application do not impose any restrictions on the specific types of terminal devices.

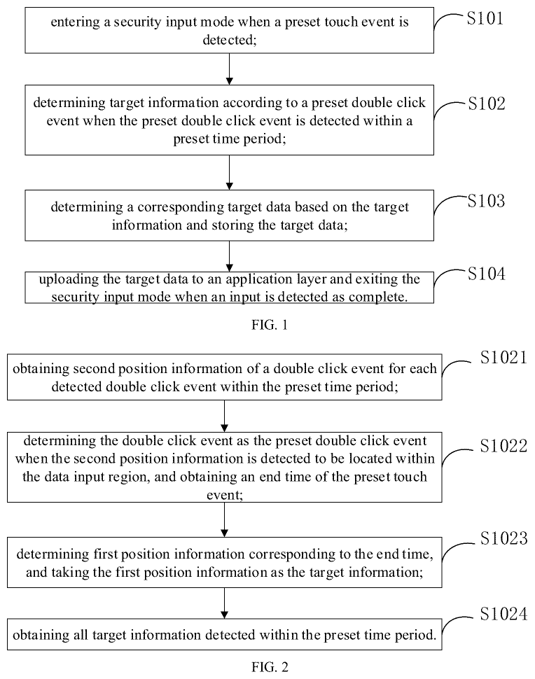

FIG. 1 shows a schematic flowchart of a multi-touch data input method provided in the present application, which can be applied to the security processor as an example rather than a limitation.

In a step S101, entering a security input mode when a preset touch event is detected.

Specifically, when an user needs to input a password, the hardware switch of the point of sale is required to be toggled, so that the point of sale is switched from the application layer to the touch screen layer (which is controlled by the security processor to obtain the status of user input data). When a preset touch event triggered by the user on the touch screen of the point of sale is detected, and the user is determined that the password input operation is currently performed, then the security input mode is entered. The security input mode refers to the mode in which the security processor determines the input data based on the touch data of the touch screen.

In a step S102, determining target information according to a preset double click event when the preset double click event is detected within a preset time period.

Specifically, the first preset duration (i.e. the preset time period) starts from the end time of the preset touch event, each time when the user triggers a preset double click event on the touch screen, the corresponding target information is determined based on the preset double click event, and all target information within the preset time period are obtained. The preset time period refers to the time period starting from the end time of the preset touch event, and the duration is a time period of the first preset time period.

Specifically, in order to avoid password input errors caused by accidentally triggering the preset touch event or the preset double click event. A preset time period needs to be preset to regulate the effective duration of password input operations after detecting the preset touch event. That is, the corresponding target information can only be determined when the preset double click event is detected within the first preset duration starting from the end time of the preset touch event. The preset double click event that occurs outside the preset time period is considered a misoperation and will not be handled in any way. The first preset duration can be set according to the actual situation.

For example, the first preset duration is set to be 3 seconds, the end time of the preset touch event is 10:00 02, and the corresponding preset time period refers to the time period from 10:00 02 to 10:00 05.

Specifically, when the preset touch event is detected as being updated to a release event, the preset touch event is determined to be ended, and the occurrence event of the release time is obtained as the end time of the preset touch event.

In a step S103, determining a corresponding target data based on the target information and storing the target data.

Specifically, the corresponding target data is obtained by querying the preset data comparison table based on the target information and then stored.

In an embodiment, it is necessary to first divide the keyboard region into non input regions (excluding numeric and function keys) and data input regions, and divide the data input regions into a plurality of preset regions. Each preset region is assigned a corresponding preset data (including but not limited to function keys such as 0-10 numeric keys, completion, clear, delete, etc.), the correlation between each preset data and the corresponding preset region is established to obtain a preset data comparison table, and store the preset data comparison table in the security processor.

In a step S104, uploading the target data to an application layer and exiting the security input mode when an input is detected to have been completed.

Specifically, when it is determined that the password input operation by the user is completed, all target data obtained within the preset time period are uploaded to the application layer and the security input mode is exited.

In an embodiment, the step 101 of entering the security input mode when the preset touch event is detected includes:
a step S1011, obtaining first position information of a touch event when the touch event is detected and the touch event is a movement event; and
a step S1012, determining the touch event as the preset touch event when the first position information is detected to be located within a data input region and a touch duration is greater than or equal to a preset touch duration, and entering the security input mode; the touch duration is a duration from an occurrence time to an end time of the touch event.

Specifically, when the user triggers a touch event through the touch screen, it is detected whether the touch event is a movement event. When the touch event is detected as the movement event, the first position information (the first position information refers to all position information of the touch event from the occurrence time to the end time) of the touch event is obtained. When the first position information is detected to be in the data input region, the touch duration is determined based on the occurrence time to the end time of the touch event. When the touch duration is detected to be greater than or equal to the preset touch duration, it is determined that the user is performing a password input operation, that is, the touch event is the preset touch event, and the security input mode is entered.

It can be understood that the touch events include a pressing event, a releasing event, and a movement event. During the process of triggering the movement event, a plurality of position information are generated accordingly. In order to ensure that the user can enter the password correctly, it is necessary to obtain all position information from the occurrence time to the end time of the touch event to ensure that the user always stays in the data input region while sliding on the touch screen.

As an example rather than a limitation, the step of detecting whether the touch event is a movement event includes: detecting that the touch event is a pressing event, and determining that the touch event is a movement event when the touch event occurs at a displacement greater than or equal to the preset displacement within the second preset duration from the occurrence time of the touch event. The second preset duration refers to the minimum triggering duration of the movement event. The second preset duration and preset displacement can be set according to actual needs. For example, the second preset duration threshold is set to be 20 ms and the preset displacement is set to be 50 pixels. When the touch event is detected as a pressing event and a displacement of more than or equal to 50 pixels occurs within 20 ms from the occurrence time of the touch event, it is determined that the touch event is a movement event.

As an example rather than a limitation, each keyboard includes four corners, and the user can determine the sliding position through the four corners of the keyboard. Correspondingly, when the first position information of the user is detected at a certain corner of the keyboard, a first preset prompt sound (such as “beep”) can be emitted to remind the users that they have slid to the edge of the keyboard and avoid sliding out of the keyboard region. When the first position information of the user is detected to be located at the boundary of the data input region, a second preset prompt sound (such as “Do”) is emitted to remind the users that they have slid to the edge of the data input region and avoids triggering other misoperations.

As shown in FIG. 2, in an embodiment, the step S102 of determining the target information according to the preset double click event when the preset double click event is detected within the preset time period includes:
a step S1021, obtaining second position information of a double click event for each detected double click event within the preset time period:
a step S1022, determining the double click event as the preset double click event when the second position information is detected to be located within the data input region, and obtaining an end time of the preset touch event:
a step S1023, determining first position information corresponding to the end time, and taking the first position information as the target information; and
a step S1024, obtaining all target information detected within the preset time period.

Specifically, taking the end time that the user triggers a preset touch event through the touch screen as the stating time, and the duration is within a preset time period of the first present duration, the second position information of the double click event is obtained every time when the user simultaneously triggers a double click event through the touch screen is detected; when the second position information is detected to be in the data input region, it is determined that the double click event is a preset double click event (i.e., the user inputs a password information by double clicking the touch screen in the data input region), the end time of the preset touch event is obtained, the first position information corresponding to the end time of the preset touch event (i.e., the position information corresponding to the release event) is determined, and the first position information is used as the target information; and the target information detected within the first preset time period, starting from the end time when the user triggers a preset touch event through the touch screen, is obtained.

As an example rather than a limitation, the double click event refers to two click events that occur within a preset time interval for the same position information.

Specifically, the security processor is provided with a timer function (configured to support sliding function) and a real-time task interrupt reporting program. When the user triggers the preset touch event, an interrupt is generated, and the security processor enters the press interrupt processing function. In the press interrupt processing function, coordinate information conversion is enabled (after each coordinate point information conversion is completed, a touch screen data conversion completion interrupt occurs, and the coordinate value needs to be reported once and the timer value is modified). When the timer timing is completed, the security processor will enter the timer processing function. In the timer processing function, coordinate point conversion will be restarted to enter the coordinate point conversion interrupt processing function and report the coordinate value. Thus, during the process of triggering the preset touch event by the user, the first position information corresponding to the preset double click event can be obtained in real time and multiple times within the preset time period as the target information. Therefore, the function of sliding touch and double clicking to input passwords is accessed.

In an embodiment, before determining the corresponding target data based on the target information and storing the corresponding target data, the method further includes:
entering the security input mode when the preset touch event is detected;
obtaining a third position information of the double click event for each detected double click event within the second preset time period;
determining the double click event to be a preset double click event when the third position information is detected to be located in the data input region, and taking the third position information as the target information; and
obtaining all target information detected within the preset time period.

Specifically, within a third preset duration (i.e. the second preset time period) starting from the occurrence time of the user triggering the preset touch event, every time a user simultaneously triggers a double click event through the touch screen, the third position information of the double click event is obtained. When the third position information is detected in the data input region, it is determined that the double click event is a preset double click event, and the third position is used as the target information to obtain the target information corresponding to all preset double click events detected in the second preset time period.

The second preset time period refers to the time period starting from the occurrence time of the preset touch event, with a duration being the third preset duration. The third preset duration refers to the shortest touch duration of the preset password input operation. The first preset duration can be set according to the actual situation.

For example, the third preset duration is set to be 8 seconds, the occurrence time of the preset touch event is 10:00 05, the corresponding second preset time period refers to the time period from 10:00 05 to 10:00 13, which requires to obtain the third position information of all preset double click events from 10:00 05 to 10:00 13.

For example, when a user triggers a preset touch event on the touch screen and swipes to find the button region of number 4 and then releases the finger, a preset double click event is triggered by double clicking the touch screen within the button region of aforementioned number 4, it is determined the third position information is the position information of the button region of number 4, and inputs the number 4.

In an embodiment, after detecting the preset touch event and entering security input mode, the method further includes:
generating first prompt information and uploading the first prompt information to the application layer when the preset double click event is not detected within the preset time period.

Specifically, when the preset double click event is not detected starting from the end time when the user triggers a preset touch event through the touch screen, and within the preset time period of the first preset duration, the first prompt information is generated and uploaded to the application layer. The first prompt information can be specifically set according to actual needs. For example, the first prompt information includes sending a notification to the application layer that “password information is not detected”, while also sending a third preset prompt sound “such as tick tick tick” to remind the user that no password has been entered.

It can be understood that when a user triggers a preset touch event, a fourth preset prompt sound (such as “beep-”) can be sent to prompt the user to enter a password information.

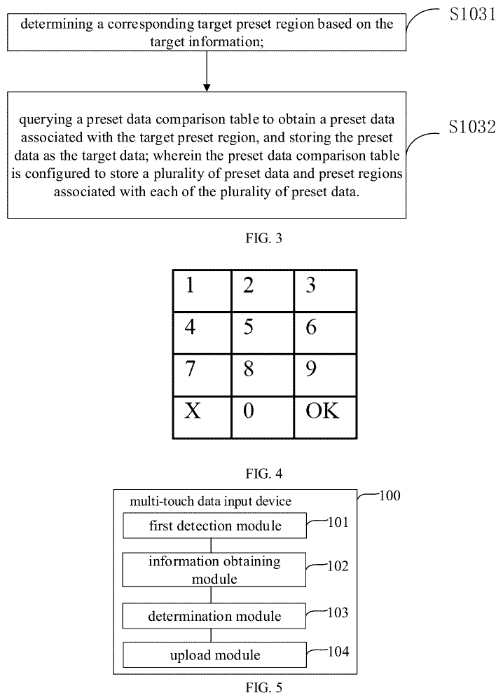

As shown in FIG. 3, in an embodiment, the step S103 of determining the corresponding target data based on the target information and storing the target data includes:
a step S1031, determining a corresponding target preset region based on the target information; and
a step S1032, querying a preset data comparison table to obtain a preset data associated with the target preset region, and storing the preset data as the target data; the preset data comparison table is configured to store a plurality of preset data and preset regions associated with each of the plurality of preset data.

Specifically, the target preset region (specifically, when the first position information is detected within the range of which preset region, the preset region is taken as the target preset region) of the preset double click event on the keyboard is determined according to the first position information corresponding to the end time of the preset touch event (i.e. target information, which is usually represented by coordinate information); and the preset data related to the target preset region is queried in the preset data comparison table and stored as the target data. The preset data comparison table is used to store a plurality of preset data and preset regions that are associated with each of the plurality of preset data.

FIG. 4 illustrates an exemplary schematic diagram of a data input region.

In FIG. 4, the data input region includes 12 preset regions, the corresponding preset data consisting of digits 0-9, an “X” function key, and an “OK” function key. The data associated with that preset region can be determined by determining which preset region the second position information is located therein. When the user triggers a preset double click event through the touch screen, the corresponding first position information is in the preset region corresponding to the “X” function key, and the corresponding target data is determined to be “deleted”, which indicates the need to delete the previous target data (i.e. the target data determined by the previous preset double click event). When the user triggers the preset double click event through the touch screen, the corresponding first position information is in the preset region corresponding to the “OK” function key, and the target data is determined to be “completed”, which indicates that the user has completed the password input operation.

For example, the password that the user needs to enter is “752”. For example, to enter 7, 5, 2, the user can start from the top left corner of the keyboard and trigger a preset touch event on the touch screen with any finger without letting go. When sliding down and hearing the first “beep-”, it indicates that the button region of number 1 has been found, the user can slide on the touch screen in the order of 1-4-7 and release the finger when the button region of number 7 has been found, then double click the touch screen with any other free finger to trigger the preset double click event, and enter the password “7”; the preset touch event is then triggered on the touch screen with any finger and do not let go, the finger is released when sliding to find the button region of number 5, the double click event is triggered by using any other free finger to double click the touch screen to enter the password “5”, and then enter the password “2” similarly; then the finger is released when sliding to find the button region of “OK”, the double click event is triggered by using any other free finger to double click the touch screen to enter information “OK” to complete the password input operation.

In an embodiment, the step of uploading the target data to the application layer and exiting the security input mode when the input is detected to have been completed includes:
uploading all stored target data to an application terminal and exiting the security input mode when the target data is detected as a completed data.

Specifically, when it is detected that the target data is the completed data (specifically, when the user triggers a preset touch event through the touch screen, determines the preset region corresponding to the “OK” function key, and triggers the preset double click event), and the obtained target data is the completed password (i.e., the number of target data is the same as the number of passwords), all obtained and stored target data are uploaded to the application end and exit the security input mode. Simultaneously the fifth preset prompt sound “such as ding dong” is sent to indicate that the password has been uploaded.

As an example rather than a limitation, when it is detected that the target data is completed data and the number of obtained target data is insufficient (for example, setting a password that includes 6 digits, while the existing target data only includes 5), a sixth preset prompt sound (such as “xi-”) can be then sent to remind the user that the number of passwords is insufficient.

In an embodiment, the method further includes:
exiting the security input mode when the touch event is detected as a release event.

Specifically, when the touch event is detected as the release event, it is determined that the preset touch event has ended, or that the touch event is not the preset touch event, and the security input mode is exited.

In an embodiment, after determining the corresponding target data based on the target information and storing the corresponding target data, the method further includes:
deleting a previous target data when the target data is detected as a deleted data, and the previous target data is a target data determined based on a previous preset double click event.

Specifically, when the target data is detected as the deleted data, the target data determined based on the previous preset double click event (i.e. the previous target data) is deleted.

For example, the current target data determined by the preset double click event includes “12345”, and when the target data determined by the preset double click event is detected as deleted data, the target data “5” is deleted, and the obtained target data includes “1234”.

In the embodiment of the present application, the multi-touch signals of the touch screen is supported and processed through the security processor, which achieves data input operations based on software logic instead of relying on Braille physical components; the device cost of the point of sale is reduced, the applicability of the point of sale is improved, and the security and efficiency of password input operations for visually impaired users are improved.

It should be understood that the size of the sequence numbers of each step in the above embodiments does not imply the order of execution. The execution order of each process should be determined by its function and internal logic, and should not constitute any limitation on the implementation process of the embodiment of the present application.

Corresponding to the multi-touch data input method described in the previous embodiments, FIG. 5 shows the structural diagram of the multi-touch data input device provided in the embodiment of the present application. For ease of explanation, only the relevant parts of the embodiment of the present application are shown.

As shown in FIG. 5, the multi-touch data input device 100 includes:
a first detection module 101, which is configured for entering a security input mode when a preset touch event is detected;
an information obtaining module 102, which is configured for determining target information according to a preset double click event when the preset double click event is detected within a preset time period;
a determination module 103, which is configured for determining a corresponding target data based on the target information and storing the target data; and
an upload module 104, which is configured for uploading the target data to an application layer and exiting the security input mode when an input is detected to have been completed.

In an embodiment, the first detection module includes:
an event obtaining unit, which is configured for obtaining first position information of a touch event when the touch event is detected and the touch event is a movement event; and
a first detection unit, which is configured for determining the touch event as the preset touch event when the first position information is detected to be located within a data input region and a touch duration is greater than or equal to a preset touch duration, and entering the security input mode; and the touch duration is a duration from an occurrence time to an end time of the touch event.

In an embodiment, the information obtaining module includes:
a position information obtaining unit, which is configured for obtaining second position information of a double click event for each detected double click event within the preset time period;
a second detection unit, which is configured for determining the double click event as the preset double click event when the second position information is detected to be located within the data input region, and obtaining an end time of the preset touch event;
an information determination unit, which is configured for determining first position information corresponding to the end time, and taking the first position information as the target information; and
target information obtaining unit, which is configured for obtaining all target information detected within the preset time period.

In an embodiment, the device further includes:
a generation module, which is configured for generating first prompt information and uploading the first prompt information to the application layer when the preset double-click event is not detected within the preset time period.

In an embodiment, the determination module includes:
a region determination unit, which is configured for determining a corresponding target preset region based on the target information; and
a querying unit, which is configured for querying a preset data comparison table to obtain a preset data associated with the target preset region, and storing the preset data as the target data; and the preset data comparison table is configured to store a plurality of preset data and preset regions associated with each of the plurality of preset data.

In an embodiment, the uploading module is specifically configured for uploading all stored target data to an application terminal and exiting the security input mode when the target data is detected as completion data.

In an embodiment, the device further includes:
a detection module, which is configured for deleting a previous target data when the target data is detected as a deleted data, and the previous target data is a target data determined based on a previous preset double click event.

In the embodiment of the present application, the multi-touch signals of the touch screen is supported and processed through the security processor, which achieves data input operations based on software logic instead of relying on Braille physical components; the device cost of the point of sale is reduced, the applicability of the point of sale is improved, and the security and efficiency of password input operations for visually impaired users are improved.

It should be noted that the information exchange and execution process between the above-mentioned devices/units are based on the same concept as the embodiments of method of the present application. The specific functions and technical effects can be found in the embodiments section of the method, which will not be repeated here.

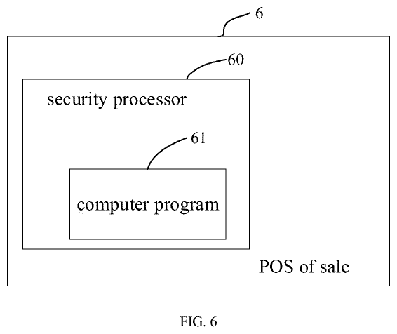

FIG. 6 is a structural schematic diagram of a point of sale provided in the embodiment. As shown in FIG. 6, the point of sale 6 of the embodiment includes: at least one security processor 60 (only one is shown in FIG. 6), a computer program 61 stored and operable on the security processor, and any of the steps in the above embodiments of the multi-touch data input method when the security processor 60 executes the computer program 61.

The point of sale 6 can be a Point Of Sale (POS). The point of sale can include, but is not limited to, a security processor 60. Those skilled in the art can understand that FIG. 6 is only an example of the point of sale 6 and does not constitute a limitation on point of sale 6. It may include more or fewer components than shown in the diagram, or combinations of certain components, or different components, such as input/output devices, network access devices, etc. The security processor 60 can be a Security processor (SP).

It can be clearly understood by the those skilled in the art that, for describing conveniently and concisely, dividing of the aforesaid various functional units, functional modules is described exemplarily merely, in an actual application, the aforesaid functions can be assigned to different functional units and functional modules to be accomplished, that is, an inner structure of a data synchronizing device is divided into functional units or modules so as to accomplish the whole or a part of functionalities described above. The various functional units, modules in the embodiments can be integrated into a processing unit, or each of the units exists independently and physically, or two or more than two of the units are integrated into a single unit. The aforesaid integrated unit can by either actualized in the form of hardware or in the form of software functional units. In addition, specific names of the various functional units and modules are only used for distinguishing from each other conveniently, but not intended to limit the protection scope of the present application. Regarding a specific working process of the units and modules in the aforesaid device, reference can be made to a corresponding process in the aforesaid method embodiments, it is not repeatedly described herein.

The embodiment of the present application further provides a computer-readable storage medium, and the computer-readable storage medium stores a computer program, and when the computer program is executed by the processor, the steps in the above embodiments of the method can be implemented.

The embodiment of the present application provides a computer program product that, when running on a mobile terminal, enables the mobile terminal to execute the steps described in the above embodiments of method.

If the integrated unit is achieved in the form of software functional units, and is sold or used as an independent product, it can be stored in a computer readable storage medium. Based on this understanding, a whole or part of flow process of implementing the method in the aforesaid embodiments of the present application can also be accomplished by using computer program to instruct relevant hardware. When the computer program is executed by the processor, the steps in the various method embodiments described above can be implemented. The computer program comprises computer program codes, which can be in the form of source code, object code, executable documents or some intermediate form, etc. The computer readable medium can include: any entity or device that can carry the computer program codes, recording medium, USB flash disk, mobile hard disk, hard disk, optical disk, computer storage device, ROM (Read-Only Memory), RAM (Random Access Memory) etc.

In the embodiments of the present application, the descriptions of the embodiments in the present application are emphasized respectively, regarding the part in some embodiments which is not described in detail, reference can be made to related descriptions in other embodiments.

Those skilled in the art may aware that, the elements and algorithm steps of each of the examples described in connection with the embodiments disclosed herein can be implemented in electronic hardware, or in combination with computer software and electronic hardware. Whether these functions are implemented by hardware or software depends on the specific application and design constraints of the technical solution. The skilled people could use different methods to implement the described functions for each particular application, however, such implementations should not be considered as going beyond the scope of the present application.

It should be understood that, in the embodiments of the present application, the disclosed device/terminal device and method could be implemented in other ways. For example, the device described above are merely illustrative; for example, the division of the units is only a logical function division, and other division could be used in the actual implementation, for example, multiple units or components could be combined or integrated into another system, or some features can be ignored, or not performed. In another aspect, the coupling or direct coupling or communicating connection shown or discussed could be an indirect, or a communicating 20) connection through some interfaces, devices or units, which could be electrical, mechanical, or otherwise.

The units described as separate components could or could not be physically separate, the components shown as units could or could not be physical units, which can be located in one place, or can be distributed to multiple network elements. Parts or all of the elements could be selected according to the actual needs to achieve the object of the present embodiment.

As stated above, the aforesaid embodiments are only intended to explain but not to limit the technical solutions of the present application. Although the present application has been explained in detail with reference to the above-described embodiments, it should be understood for the ordinary skilled one in the art that, the technical solutions described in each of the above-described embodiments can still be amended, or some technical features in the technical 30) solutions can be replaced equivalently; these amendments or equivalent replacements, which won't make the essence of corresponding technical solution to be broken away from the spirit and the scope of the technical solution in various embodiments of the present application, should all be included in the protection scope of the present application.

1. A multi-touch data input method, applied to a security processor, comprising:
entering a security input mode when a preset touch event is detected;
determining target information according to a preset double click event when the preset double click event is detected within a preset time period;
determining a target data corresponding to the target information based on the target information and storing the target data; and
uploading the target data to an application layer and exiting the security input mode when an input is detected to have been completed.

2. The multi-touch data input method according to claim 1, wherein the step of entering the security input mode when the preset touch event is detected comprises:
obtaining first position information of a touch event when the touch event is detected and the touch event is a movement event; and
determining the touch event as the preset touch event when the first position information is detected to be located within a data input region and a touch duration is greater than or equal to a preset touch duration, and entering the security input mode; wherein the touch duration is a duration from an occurrence time to an end time of the touch event.

3. The multi-touch data input method according to claim 2, wherein the step of determining the target information according to the preset double click event when the preset double click event is detected within the preset time period comprises:
obtaining second position information of a double click event for each detected double click event within the preset time period;
determining the double click event as the preset double click event when the second position information is detected to be located within the data input region, and obtaining an end time of the preset touch event;
determining first position information corresponding to the end time, and taking the first position information as the target information; and
obtaining all target information detected within the preset time period.

4. The multi-touch data input method according to claim 3, wherein after the step of entering the security input mode when the preset touch event is detected, the method further comprises:
generating first prompt information and uploading the first prompt information to the application layer when the preset double click event is not detected within the preset time period.

5. The multi-touch data input method according to claim 3, wherein the step of determining the target data corresponding to the target information based on the target information and storing the target data comprises:
determining a target preset region corresponding to the target information based on the target information; and
querying a preset data comparison table to obtain a preset data associated with the target preset region, and storing the preset data as the target data; wherein the preset data comparison table is configured to store a plurality of preset data and preset regions associated with each of the plurality of preset data.

6. The multi-touch data input method according to claim 1, wherein the step of uploading the target data to the application layer and exiting the security input mode when the input is detected to have been completed comprises:
uploading all stored target data to an application terminal and exiting the security input mode when the target data is detected as a completed data.

7. The multi-touch data input method according to claim 1, wherein after the step of determining the target data corresponding to the target information based on the target information and storing the target data, the method further comprises:
deleting a previous target data when the target data is detected as a deleted data, wherein the previous target data is a target data determined based on a previous preset double click event.

8. (canceled)

9. A point of sale, comprising a security processor and a computer program stored and operable on the security processor, wherein when the computer program is executed the security processor implements the following steps:
entering a security input mode when a preset touch event is detected;
determining target information according to a preset double click event when the preset double click event is detected within a preset time period;
determining a target data corresponding to the target information based on the target information and storing the target data; and
uploading the target data to an application layer and exiting the security input mode when an input is detected to have been completed.

10. A non-transitory computer-readable storage medium stores a computer program, wherein when the computer program is executed by a security processor to implement the following steps:
entering a security input mode when a preset touch event is detected;
determining target information according to a preset double click event when the preset double click event is detected within a preset time period;
determining a target data corresponding to the target information based on the target information and storing the target data; and
uploading the target data to an application layer and exiting the security input mode when an input is detected to have been completed.

11. The multi-touch data input method according to claim 2, wherein after the step of determining the target data corresponding to the target information based on the target information and storing the target data, the method further comprises:
deleting a previous target data when the target data is detected as a deleted data, wherein the previous target data is a target data determined based on a previous preset double click event.

12. The multi-touch data input method according to claim 3, wherein after the step of determining the target data corresponding to the target information based on the target information and storing the target data, the method further comprises:
deleting a previous target data when the target data is detected as a deleted data, wherein the previous target data is a target data determined based on a previous preset double click event.

13. The multi-touch data input method according to claim 4, wherein after the step of determining the target data corresponding to the target information based on the target information and storing the target data, the method further comprises:
deleting a previous target data when the target data is detected as a deleted data, wherein the previous target data is a target data determined based on a previous preset double click event.

14. The multi-touch data input method according to claim 5, wherein after the step of determining the target data corresponding to the target information based on the target information and storing the target data, the method further comprises:
deleting a previous target data when the target data is detected as a deleted data, wherein the previous target data is a target data determined based on a previous preset double click event.

15. The multi-touch data input method according to claim 6, wherein after the step of determining the target data corresponding to the target information based on the target information and storing the target data, the method further comprises:
deleting a previous target data when the target data is detected as a deleted data, wherein the previous target data is a target data determined based on a previous preset double click event.

16. The multi-touch data input method according to claim 7, wherein after the step of determining the target data corresponding to the target information based on the target information and storing the target data, the method further comprises:
deleting a previous target data when the target data is detected as a deleted data, wherein the previous target data is a target data determined based on a previous preset double click event.
